(19) United States
(12) Patent Application Publication
(10) Pub. No.: US 2020/0080669 A1
(43) Pub. Date: Mar. 12, 2020

(54) REINFORCED TUBING AND METHOD OF MAKING THE SAME

(71) Applicant: Wen Chieh Hsieh, Xiamen City (CN)

(72) Inventor: Wen Chieh Hsieh, Xiamen City (CN)

(21) Appl. No.: 16/122,878

(22) Filed: Sep. 6, 2018

(51) Int. Cl. F16L 11/12; F16L 11/08; B29C 47/00; B29C 47/02

(52) U.S. Cl. CPC F16L 11/12; F16L 11/08; B29C 47/0026; B29K 2083/00; B29C 47/027; B29C 47/0066; B29C 2793/009; B29C 47/025

(57) ABSTRACT

A reinforced tubing comprising a shaft, a tubular body, and two or more reinforcing members is provided. The shaft has a lumen extending from a proximal port to a distal port having an inner and outer polymer layer. At least a portion of the shaft includes a tubular body and a tubular body reinforced by two or more reinforcing members. A chemical and heat treatment is performed to the two or more reinforcing members, forming an antibacterial surface thereon. A method of making a tubular body for a reinforced tubing shaft is provided. The method comprises providing two or more reinforcing members, providing a reinforced tubing mold and an extruder operatively associated therewith, attaching the two or more reinforcing members to the reinforced tubing mold, and extruding a polymer material into the reinforced tubing mold, wherein the polymer material surrounds the two or more reinforcing members forming the reinforced tubing.

### BACKGROUND OF THE INVENTION

### Field of the Invention

The invention relates to polymer tubing, and more particularly, to reinforced tubing and method of making the same.

### Description of the Related Art

Stainless steel is a low maintenance, corrosion resistant material that is widely used in a variety of industries. The alloy can be made into stainless steel plates, bars, wire, sheets and tubing, for use in manufacturing surgical instruments, appliances, cookware and cutlery, and industrial equipment etc. However, stainless steel is an inert material and is not in itself bioactive. Thus, despite being used in kitchens, food processing plants, hospitals, medical offices, surgical centers and other industries, disease-causing bacterial can form on its surfaces if not cleaned and sterilized often.

For making stainless steel antibacterial, bioavailable silver or copper atoms can be coated on the metal surface, as silver and copper are powerful bactericides. However, current techniques are complex, costly, wear off easily and can be harmful to the environment.

Food grade silicone is a non-toxic type of silicone that doesn't contain chemical fillers or byproducts. In the U.S., food grade silicone is regulated by the FDA, and in EU countries, LFGB (Germany) or DGCCRF (France) certification is often sought for commercial application. In addition to being an abundant natural resource, non-toxic and odorless, and recyclable, food grade silicone can withstand operating temperatures of between −40° Celsius to +240° Celsius.

Food grade silicone and stainless steel have been combined for use in a variety of products for a variety of industries. While both have been used for tubing, the challenges of making stainless steel antibacterial over time still remains, and additionally, bondability between stainless steel and silicone for durability and lastability is also a challenge.

There is demand for reinforced tubing and methods for making the same to solve the aforementioned problems.

### BRIEF SUMMARY OF THE INVENTION

Reinforced tubing and methods of making the same are provided.

In an embodiment, a reinforced tubing comprising a shaft, a tubular body, and two or more reinforcing members is provided. The shaft is flexible and has a proximal end and distal end. The shaft also has a lumen extending from a proximal port to a distal port having an inner and outer polymer layer. In the embodiments, the inner and outer polymer layers are made of silicone. In an embodiment, at least a portion of the shaft includes a tubular body and a tubular body being reinforced by two or more reinforcing members extending laterally between the inner and outer polymer layers; however, the embodiment is not limited thereto. In alternative embodiments, portions of the tubular body have different flexibilities via the two or more reinforcing members. In the embodiments, the two or more reinforcing members are a stainless steel wire. In the embodiments, the shape of the two or more reinforcing members is cylindrical.

In the embodiments, a chemical treatment and heat treatment is performed to the two or more reinforcing members. An inorganic solvent bath is employed in the chemical treatment, forming a plurality of cavities on the outer surface of the two or more reinforcing members. In the embodiments, the ratio of inorganic solvent to water for the chemical treatment in the inorganic solvent bath forming the plurality of cavities on the outer surface of the two or more reinforcing members is in the range from 1.15:1 to 1.45:1. An antibacterial surface is formed on the two or more reinforcing members following the heat treatment. In the embodiments, the temperature of the heat treatment for forming the antibacterial surface on the outer surface of the two or more reinforcing members is in the range from 470° C. to 760° C. In the embodiments, the time period of the heat treatment for forming the antibacterial surface on the outer surface of the two or more reinforcing members is in the range 10 minutes to 60 minutes.

In an embodiment, a method of making a tubular body for a reinforced tubing shaft is provided. The reinforced tubing comprises a shaft, a tubular body, and two or more reinforcing members. In the embodiments, the method comprises providing two or more reinforcing members. In the embodiments, the two or more reinforcing members are a stainless steel wire and the shape of the two or more reinforcing members is cylindrical. Following, the surfaces of the two or more reinforcing members are cleaned and rinsed. Then, they are immersed in an inorganic solvent bath for chemical treatment. In the embodiments, the ratio of inorganic solvent to water for the chemical treatment in the inorganic solvent bath is in the range from 1.15:1 to 1.45:1. Following the chemical treatment, a plurality of cavities is formed on the two or more reinforcing members. Next, the two or more reinforcing members are rinsed and dried and prepared for heat treatment. Then, the two or more reinforcing members are heat treated. In the embodiments, the temperature of the heat treatment is in the range from 470° C. to 760° C. Following heat treatment, an antibacterial surface is formed on the two or more reinforcing members. In the embodiments, the time period of the heat treatment for forming the antibacterial surface on the outer surface of the two or more reinforcing member is in the range 10 minutes to 60 minutes.

Following, in the method of making a tubular body for a reinforced tubing shaft, a reinforced tubing mold and an extruder operatively associated with the two or more reinforcing members are provided. The two or more reinforcing members are attached to the reinforced tubing mold. Next, a polymer material with a melting temperature is extruded into the reinforced tubing mold, wherein the polymer material surrounds the two or more reinforcing members forming a lumen and an inner and outer polymer layer. In the embodiments, the inner and outer polymer layers are made of silicone. After, the tubular body is heated for bonding of the polymer material with the two or more reinforcing members. In an embodiments, the tubular body can next be cut and removed after cooling, forming the reinforced tubing for a reinforced tubing shaft.

In the embodiments of the method of making a tubular body for a reinforced tubing shaft, the shaft is flexible and has a proximal end and distal end. The lumen of the shaft extends from a proximal port to a distal port. In an embodiment, at least a portion of the shaft includes a tubular body and a tubular body being reinforced by two or more reinforcing members extending laterally between the inner and outer polymer layers; however, the embodiment is not limited thereto. In alternative embodiments, portions of the tubular body have different flexibilities via the two or more reinforcing members.

These, as well as other components, steps, features, benefits, and advantages of the present application, will now made clear by reference to the following detailed description of the embodiments, the accompanying drawings, and the claims.

### BRIEF DESCRIPTION OF THE DRAWINGS

The accompanying drawings, which are incorporated herein and form a part of the Detailed Description of the Invention, illustrate various embodiments of the present invention and, together with the Detailed Description of the Invention, serve to explain principles discussed below. The drawings referred to in this Brief Description of Drawings should not be understood as being drawn to scale unless specifically noted.

FIG. 1 is a schematic perspective view illustrating a reinforced tubing having two reinforcing members according to various embodiments.

FIG. 2 is a schematic perspective view illustrating an alternative reinforced tubing having two reinforcing members according to various embodiments.

FIG. 3 is a schematic cross-sectional view illustrating the reinforced tubing of FIG. 2 having two reinforcing members according to various embodiments.

FIG. 4 is a schematic enlarged cross-sectional view illustrating a reinforcing member according to various embodiments.

FIG. 5 is a schematic longitudinal cross-sectional view illustrating a reinforcing member according to various embodiments.

FIG. 6 is a schematic cross-sectional view illustrating an extruder and reinforced tubing mold according to various embodiments.

FIG. 7 is a schematic cross-sectional enlarged view illustrating the outlet A of the extruder and reinforced tubing mold of FIG. 6 according to various embodiments

FIG. 8 is a flow chart illustrating a method of making a tubular body for a reinforced tubing shaft according to various embodiments.

### DETAILED DESCRIPTION OF THE INVENTION

It is understood that the following disclosure provides many different embodiments, or examples, for implementing different features of the invention. Specific examples of devices and arrangements are described below to simplify the present disclosure. These are, of course, merely examples and are not intended to be limiting. For example, the formation of a first feature over or on a second feature in the description that follows can include embodiments in which the first and second features are formed in direct contact, and can also include embodiments in which additional features are formed between the first and second features, such that the first and second features are not in direct contact. In addition, the present disclosure can repeat reference numerals and/or letters in the various examples. This repetition is for the purpose of simplicity and clarity and does not in itself dictate a relationship between the various embodiments and/or configurations discussed. It is intended that the scope of the present technology be defined by the claims appended hereto and their equivalents.

A reinforced tubing comprising a shaft, a tubular body, and two or more reinforcing members is provided. The shaft has a lumen extending from a proximal port to a distal port having an inner and outer polymer layer. At least a portion of the shaft includes a tubular body and a tubular body being reinforced by two or more reinforcing members. A chemical treatment and heat treatment is performed to the two or more reinforcing members, forming an antibacterial surface thereon. A method of making a tubular body for a reinforced tubing shaft is provided. The method comprises providing two or more reinforcing members, providing a reinforced tubing mold and an extruder operatively associated therewith, attaching the two or more reinforcing members to the reinforced tubing mold, and extruding a polymer material into the reinforced tubing mold, wherein the polymer material surrounds the two or more reinforcing members forming the reinforced tubing.

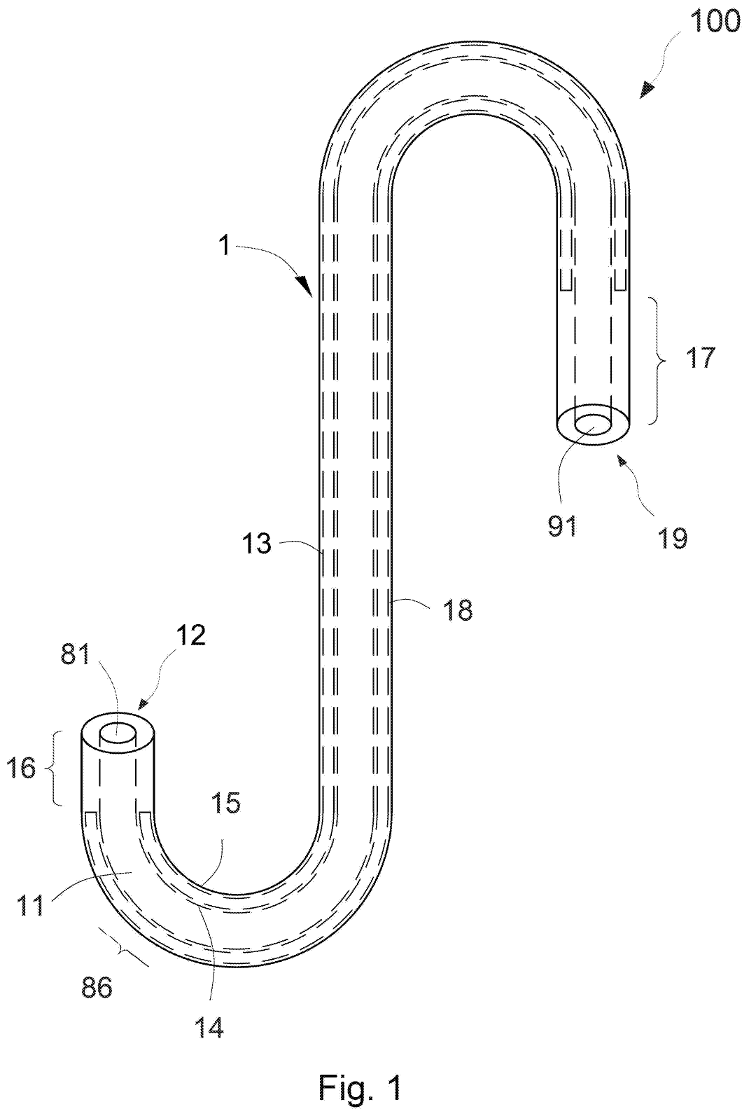

FIG. 1 is a schematic perspective view illustrating a reinforced tubing having two reinforcing members according to various embodiments. As shown in FIG. 1, in an embodiment, a reinforced tubing 100 comprising a shaft 1, a tubular body 16, 17, 86, and two or more reinforcing members 13, 18 is provided. The shaft 1 is flexible and has a proximal end 12 and distal end 19. The shaft 1 also has a lumen 11 extending from a proximal port 81 to a distal port 91 having an inner polymer layer 14 and outer polymer layer 15. In the embodiments, the inner and outer polymer layers 14, 15, respectively, are made of silicone, for example, and not to be limiting, food grade silicone; however, the embodiments are not limited thereto. Other biodegradable polymer materials with a melting temperature can be employed. In an embodiment, at least a portion of the shaft 1 includes a tubular body 16, 17 and a tubular body 86 being reinforced by two or more reinforcing members 13, 18 extending laterally between the inner and outer polymer layers 14, 15; however, the embodiment is not limited thereto. In alternative embodiments, portions of the tubular body can have different flexibilities via the two or more reinforcing members 13, 18 or similar flexibilities.

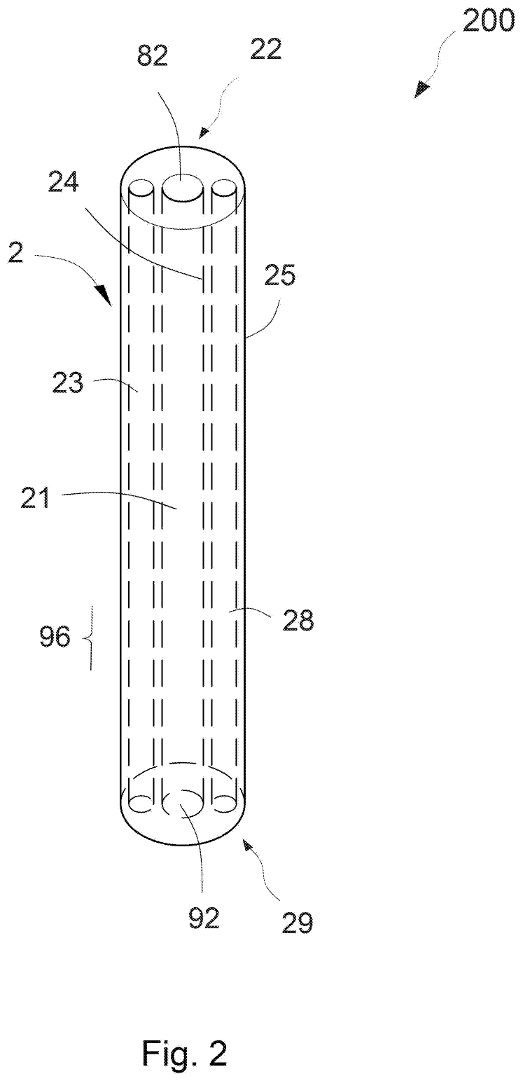

FIG. 2 is a schematic perspective view illustrating an alternative reinforced tubing having two reinforcing members according to various embodiments. As shown in FIG. 2, in an alternative embodiment, a reinforced tubing 200 comprising a shaft 2, a tubular body 96, and two or more reinforcing members 23, 28 is provided. The shaft 2 is flexible and has a proximal end 22 and distal end 29. The shaft 2 also has a lumen 21 extending from a proximal port 82 to a distal port 92 having an inner polymer layer 24 and outer polymer layer 25.

In the embodiments, the two or more reinforcing members 13, 18, 23, 28 are stainless steel wires. As an example, and not to be limiting, the stainless steel wire can comprise 50 wt % or more of iron, 12 wt % or more of chromium and 2 to 4 wt % of copper, among other elements. In the embodiments, the shape of the two or more reinforcing members 13, 18, 23, 28 is cylindrical and the outer surface diameter thereof is less than a perpendicular distance between the inner polymer and outer polymer layer 14, 24 and 15, 25, respectively. In the embodiments, the diameter of the lumen 11, 21 is greater than the outer surface diameter of the two or more reinforcing members 13, 18, 23, 28.

As an example, and not to be limiting, the two or more reinforcing members 13, 18, 23, 28 comprise a flexural rigidity and a Young's modulus higher than that of the lumen 11 of the shaft 1 having an inner polymer layer 14 and outer polymer layer 15 made of silicone, as an example, and not to be limiting, for flexibility and fixing. The structural design allows the reinforced tubing to be oriented and fixed in any direction. As an example, and not to be limiting, oriented and fixed in any angular direction and/or circular direction via twisting, etc.

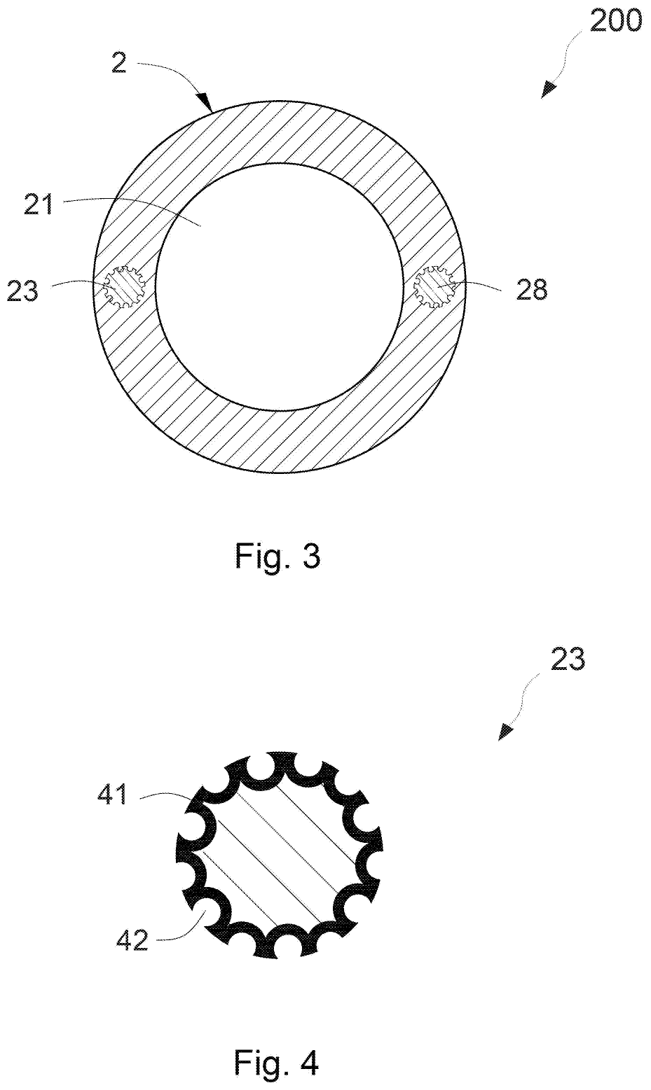

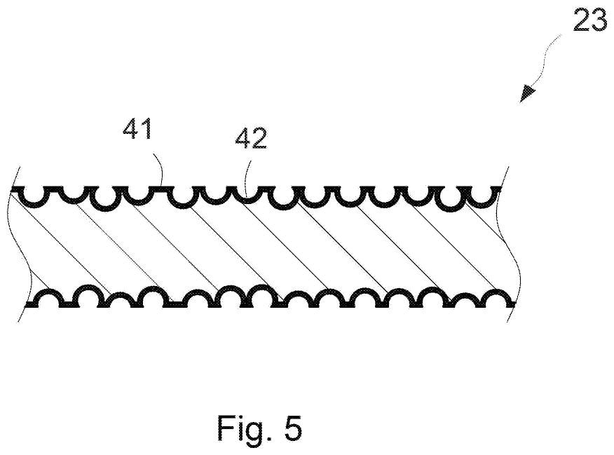

FIG. 3 is a schematic cross-sectional view illustrating the reinforced tubing of FIG. 2 having two reinforcing members according to various embodiments. FIG. 4 is a schematic enlarged cross-sectional view illustrating a reinforcing member according to various embodiments. FIG. 5 is a schematic longitudinal cross-sectional view illustrating a reinforcing member according to various embodiments. As shown in FIGS. 3 to 5, and referring again to FIG. 2, in the embodiments, a chemical treatment and heat treatment is performed to the two or more reinforcing members 23, 28. An inorganic solvent bath is employed in the chemical treatment, forming a plurality of cavities 42 on the outer surface of the two or more reinforcing members 23, 28. In the embodiments, as an example, and not to be limiting, the ratio of inorganic solvent to water for the chemical treatment in the inorganic solvent bath forming the plurality of cavities 42 on the outer surface of the two or more reinforcing members 23, 28 can range from 1.15:1 to 1.45:1.

As an example, and not to be limiting, in the embodiments, the chemical treatment and the inorganic solvent bath forming the plurality of cavities 42, can be any chemical treatment and inorganic solvent bath known to those skilled in the art for removing contaminants and forming a chromium rich and uniform passive layer. For example, and not to be limiting, the inorganic solvent bath can comprise hydrochloric acid HCl, sulfuric acid H₂SO₄, nitric acid HNO₃, phosphoric acid H₃PO₄, boric acid H₃BO₃, hydrofluoric acid HF, hydrobromic acid HBr, perchloric acid HClO₄, or the like. So long as contaminants can be removed from, and the plurality of cavities 42 can be formed on, the outer surface of the two or more reinforcing members, forming a chromium rich and uniform passive layer.

An antibacterial surface 41 is formed on the two or more reinforcing members 23, 28, including the plurality of cavities 42, following the heat treatment. In the embodiments, as an example, and not to be limiting, the temperature of the heat treatment for forming the antibacterial surface 41 on the outer surface of the two or more reinforcing members, including the plurality of cavities 42, can range from 470° C. to 760° C.; however, the embodiments are not limited thereto. The temperature of the heat treatment for forming the antibacterial surface 41 on the outer surface of the two or more reinforcing members, including the plurality of cavities 42, can range from 470° C. to 630° C., or from 540° C. to 590° C.

In the embodiments, as an example, and not to be limiting, the time period of the heat treatment for forming the antibacterial surface on the outer surface of the two or more reinforcing members, including the plurality of cavities 42 can range from 10 minutes to 60 minutes.

As an example, and not to be limiting, the antibacterial surface 41 of the two or more reinforcing members 23, 28 of the embodiments is formed by balanced formation of chromium and copper and other elements throughout the two or more reinforcing members 23, 28, including surfaces thereof. Copper(II) oxide is formed when the copper at the surface of the two or more reinforcing members 23, 28 reacts with oxygen. Copper ions released from the surfaces of the two or more reinforcing members 23, 28 can combine with proteins by electrostatic force to deform bacterial membrane, providing an antibacterial surface 41 having preventive corrosion properties. Following release of the copper ions, due to the balanced formation of copper throughout the two or more reinforcing members 23, 28, balance and stability remains, providing antibacterial surface regeneration properties.

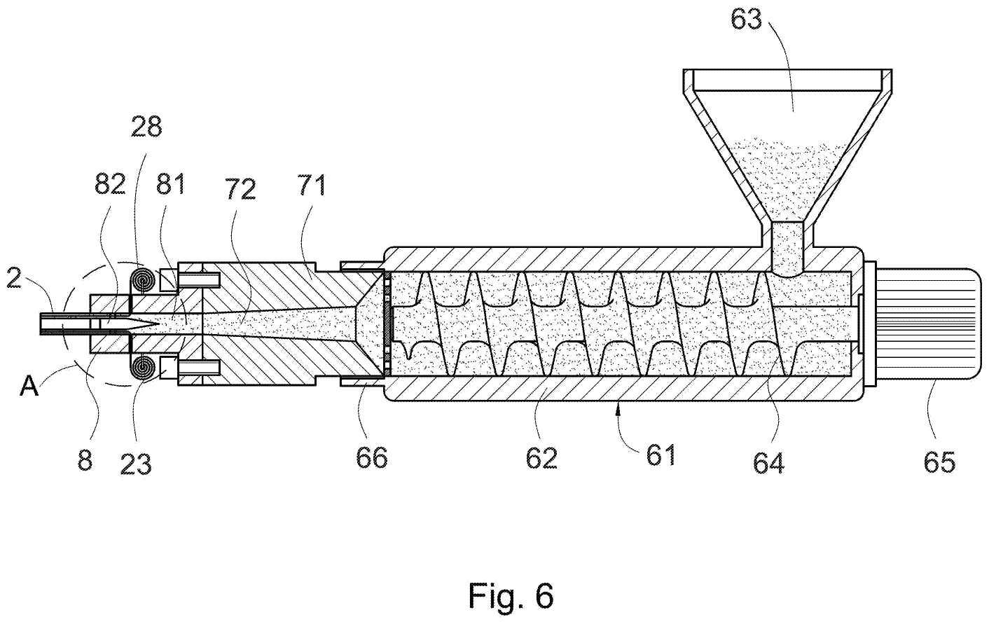

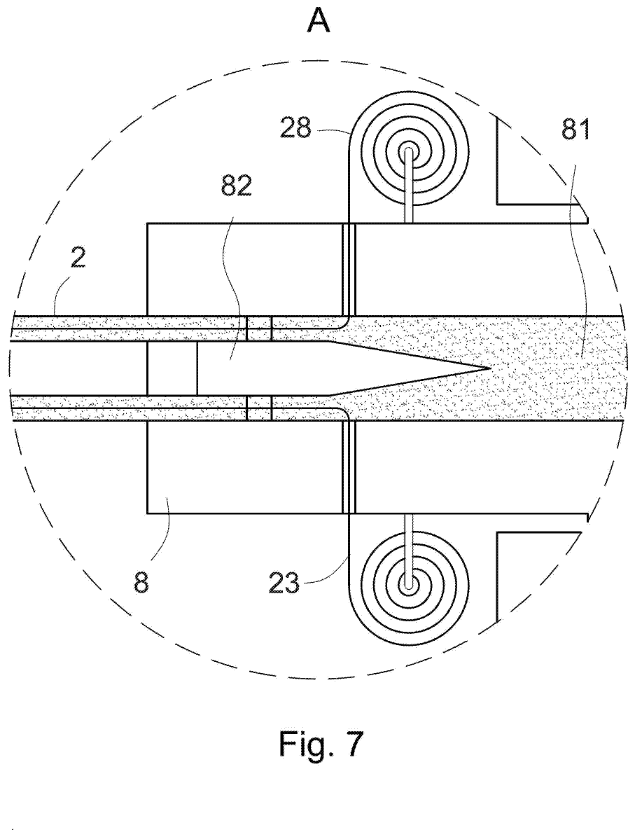

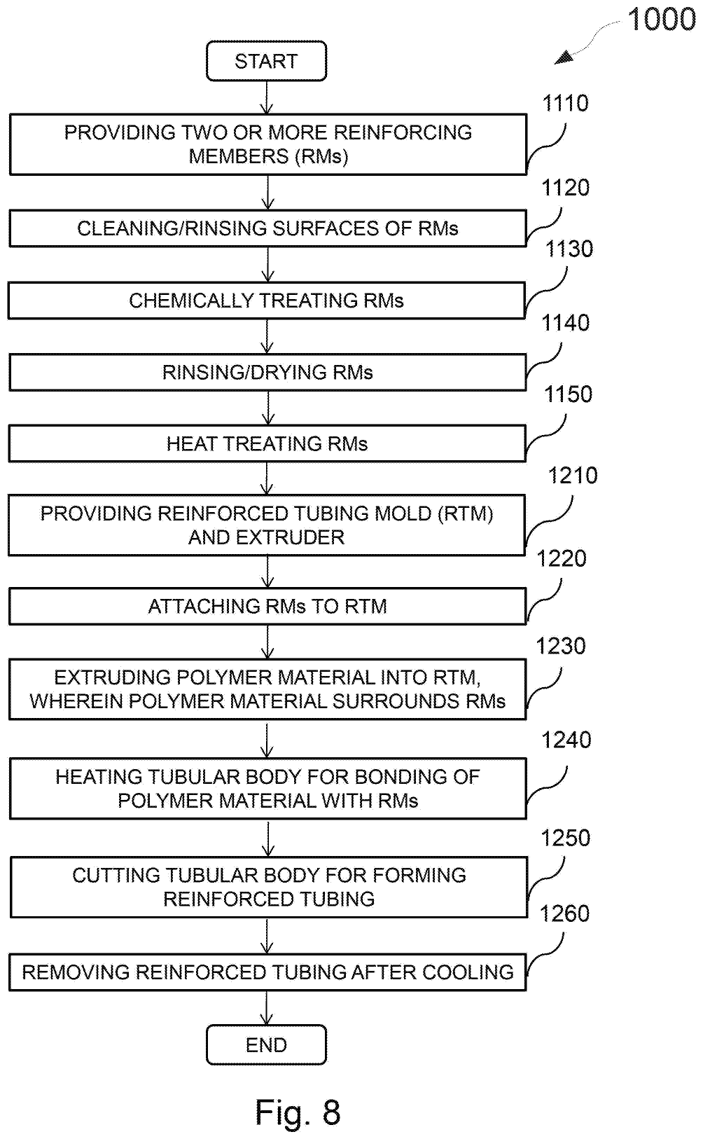

FIG. 6 is a schematic cross-sectional view illustrating an extruder and reinforced tubing mold according to various embodiments. FIG. 7 is a schematic cross-sectional enlarged view illustrating the outlet A of the extruder and reinforced tubing mold of FIG. 6 according to various embodiments. FIG. 8 is a flow chart illustrating a method of making a tubular body for a reinforced tubing shaft according to various embodiments. As shown in FIGS. 6 to 8, and referring again to FIG. 2. In an embodiment, a method 1000 of making a tubular body 200 for a reinforced tubing shaft is provided. The reinforced tubing 200 comprises a shaft 2, a tubular body 96, and two or more reinforcing members 23, 28. In the embodiments, in Step 1110, the method 1000 comprises providing two or more reinforcing members 23, 28.

In the embodiments, as an example, and not to be limiting, the two or more reinforcing members 23, 28 are stainless steel wires and the shape thereof is cylindrical. As an example, and not to be limiting, the stainless steel wire can comprise 50 wt % or more of iron, 12 wt % or more of chromium and 2 to 4 wt % of copper, among other elements.

Following, in Step 1120, the surfaces of the two or more reinforcing members 23, 28 are cleaned and rinsed. Then, in step 1130, they are immersed in an inorganic solvent bath for chemical treatment. In the embodiments, the ratio of inorganic solvent to water for the chemical treatment in the inorganic solvent bath is in the range from 1.15:1 to 1.45:1.

As an example, and not to be limiting, in the embodiments, the chemical treatment and the inorganic solvent bath forming the plurality of cavities 42, can be any chemical treatment and inorganic solvent bath known to those skilled in the art for removing contaminants and forming a chromium rich and uniform passive layer. For example, and not to be limiting, the inorganic solvent bath can comprise hydrochloric acid HCl, sulfuric acid H₂SO₄, nitric acid HNO₃, phosphoric acid H₃PO₄, boric acid H₃BO₃, hydrofluoric acid HF, hydrobromic acid HBr, perchloric acid HClO₄, or the like. So long as contaminants can be removed from, and the plurality of cavities 42 can be formed on, the outer surface of the two or more reinforcing members, forming a chromium rich and uniform passive layer.

Following the chemical treatment, a plurality of cavities 42 is formed on the two or more reinforcing members 23, 28. Next, in Step 1140, the two or more reinforcing members 23, 28 are rinsed and dried and prepared for heat treatment. Then, in Step 1150, the two or more reinforcing members 23, 28 are heat treated.

In the embodiments, the temperature of the heat treatment is in the range from 470° C. to 760° C.; however, the embodiments are not limited thereto. The temperature of the heat treatment for forming the antibacterial surface 41 on the outer surface of the two or more reinforcing members, including the plurality of cavities 42, can range from 470° C. to 630° C., or from 540° C. to 590° C. Following heat treatment, an antibacterial surface is formed on the two or more reinforcing members 23, 28, including the plurality of cavities 42. In the embodiments, the time period of the heat treatment for forming the antibacterial surface on the outer surface of the two or more reinforcing members 23, 28, including the plurality of cavities 42, is in the range 10 minutes to 60 minutes.

As an example, and not to be limiting, the antibacterial surface 41 of the two or more reinforcing members 23, 28 of the embodiments is formed by balanced formation of chromium and copper and other elements throughout the two or more reinforcing members 23, 28, including surfaces thereof. Copper(II) oxide is formed when the copper at the surface of the two or more reinforcing members 23, 28 reacts with oxygen. Copper ions released from the surfaces of the two or more reinforcing members 23, 28 can combine with proteins by electrostatic force to deform bacterial membrane, providing an antibacterial surface 41 having preventive corrosion properties. Following release of the copper ions, due to the balanced formation of copper throughout the two or more reinforcing members 23, 28, balance and stability remains, providing antibacterial surface regeneration properties.

Following, in the method of making a tubular body for a reinforced tubing shaft, in Step 1210, a reinforced tubing mold 8 and an extruder 61 operatively associated with the two or more reinforcing members 23, 28 are provided. As an example, and not to be limiting, the extruder 61 can comprise a receiving end 66, a hopper 63, a barrel 61, a screw 64, and a motor 65, extruding a polymer material with a melting temperature into the reinforced tubing mold 8.

After, in Step 1220, the two or more reinforcing members 23, 28 are attached to the reinforced tubing mold 8. As an example, and not to be limiting, the reinforced tubing mold 8 can comprise a distributive splitting channel 81 and a plug 82, and be operatively attached to a receiving mold 71 having one or more funneled sections 72 for funneling of the polymer material with a melting temperature.

Next, in Step 1230, a polymer material with a melting temperature is extruded into a distributive splitting channel 81 of the reinforced tubing mold 8, wherein the polymer material surrounds the two or more reinforcing members 23, 28 forming a lumen 21 and an inner polymer layer 24 and outer polymer layer 25. In the embodiments, the inner polymer layer 24 and outer polymer layer 25 are made of silicone, for example, and not to be limiting, food grade silicone; however, the embodiments are not limited thereto. Other biodegradable polymer materials with a melting temperature can be employed.

After, in Step 1240, the tubular body is heated for bonding of the polymer material with the two or more reinforcing members 23, 28. In the embodiments, in Step 1250 and Step 1260, the tubular body can next be cut and removed after cooling, forming the reinforced tubing for a reinforced tubing shaft.

In the embodiments of the method of making a tubular body for a reinforced tubing shaft, the shaft 2 is flexible and has a proximal end 22 and distal end 29. The lumen 21 of the shaft 2 extends from a proximal port 82 to a distal port 92. In an embodiment, at least a portion of the shaft includes a tubular body and a tubular body being reinforced by two or more reinforcing members 23, 28 extending laterally between the inner and outer polymer layers 24, 25; however, the embodiment is not limited thereto. In alternative embodiments, portions of the tubular body 96 have different flexibilities via the two or more reinforcing members 23, 28.

As an example, and not to be limiting, the outer surface diameter of the two or more reinforcing members 23, 28 is less than a perpendicular distance between the inner polymer and outer polymer layer 24, 25, respectively. In the embodiments, the diameter of the lumen 21 is greater than the outer surface diameter of the two or more reinforcing members 23, 28.

As an example, and not to be limiting, the two or more reinforcing members 23, 28 comprise a flexural rigidity and a Young's modulus higher than that of the lumen 21 of the shaft 2 having an inner polymer layer 24 and outer polymer layer 25 made of silicone, as an example, and not to be limiting, for flexibility and fixing. The structural design allows the reinforced tubing to be oriented and fixed in any direction. As an example, and not to be limiting, oriented and fixed in any angular direction and/or circular direction via twisting, etc.

Stainless steel is a low maintenance, corrosion resistant material that is widely used in a variety of industries. The alloy can be made into stainless steel plates, bars, wire, sheets and tubing, for use in manufacturing surgical instruments, appliances, cookware and cutlery, and industrial equipment etc. However, stainless steel is an inert material and is not in itself bioactive. Thus, despite being used in kitchens, food processing plants, hospitals, medical offices, surgical centers and other industries, disease-causing bacterial can form on its surfaces if not cleaned and sterilized often.

For making stainless steel antibacterial, bioavailable silver or copper atoms can be coated on the metal surface, as silver and copper are powerful bactericides. However, current techniques are complex, costly, wear off easily and can be harmful to the environment.

Food grade silicone is a non-toxic type of silicone that doesn't contain chemical fillers or byproducts. In the U.S., food grade silicone is regulated by the FDA, and in EU countries, LFGB (Germany) or DGCCRF (France) certification is often sought for commercial application. In addition to being an abundant natural resource, non-toxic and odorless, and recyclable, food grade silicone can withstand operating temperatures of between −40° Celsius to +240° Celsius.

Food grade silicone and stainless steel have been combined for use in a variety of products for a variety of industries. While both have been used for tubing, the challenges of making stainless steel antibacterial over time still remains, and additionally, bondability between stainless steel and silicone for durability and lastability is also a challenge.

The reinforced tubing of the embodiments comprises a shaft, a tubular body, and two or more reinforcing members. The shaft has a lumen extending from a proximal port to a distal port having an inner and outer polymer layer. At least a portion of the shaft includes a tubular body and a tubular body being reinforced by two or more reinforcing members. A chemical treatment and heat treatment is performed to the two or more reinforcing members, forming an antibacterial surface thereon. The reinforced tubing of the embodiments employ two or more stainless steel wires, surrounded by food grade silicone, allowing the reinforced tubing to be oriented and fixed in any angular direction and/or circular direction via twisting, etc. Also, the two or more stainless steel wires have a chromium rich and uniform passive layer following the chemical treatment, providing preventative corrosion properties thereto. In addition, in part to the composition of the two or more stainless steel wires and chemical and heat treatments performed thereto, the copper element therein is formed having balance and stability. Thus, following release of copper ions associated with the antibacterial properties thereof, balance and stability remains, providing antibacterial surface regeneration properties, making the antibacterial properties of the stainless steel last longer over time. Moreover, bondability between the two or more stainless steel wires and food grade silicone is strong via the plurality of cavities and the reinforced tubing of the embodiments is durable via the method of making the tubular body for the reinforced tubing shaft.

Those skilled in the art will appreciate that additional steps may be added to the process in order to incorporate additional features into the finished product. Also, the steps can be altered depending upon different requirements. Those skilled in the art will also appreciate that additional coatings, treatments, etc., as can be common with medical devices, sanitary equipment and industrial equipment etc., can be applied to the reinforced tubing.

The details of the construction or composition of the various elements of the reinforced tubing of the embodiments not otherwise disclosed are not believed to be critical to the present invention, so long as the recited elements poses the strength or mechanical properties needed for them to perform as disclosed. Additional details of construction are believed to be well within the ability of one of ordinary skill in the art.

Unless otherwise indicated, all numbers used herein to express quantities, dimensions, and so forth used should be understood as being modified in all instances by the term “about.” The use of the singular includes the plural unless specifically stated otherwise, and use of the terms “and” and “or” means “and/or” unless otherwise indicated.

From the foregoing it will be appreciated that, although specific embodiments have been described herein for purposes of illustration, various modifications can be made without deviating from the spirit and scope of the disclosure. Furthermore, where an alternative is disclosed for a particular embodiment, this alternative can also apply to other embodiments even if not specifically stated.

What is claimed is:

1. A reinforced tubing, comprising:
a shaft having a proximal end and distal end, the shaft, being flexible, extending between the proximal and distal ends, defining a lumen extending from a proximal port to a distal port and having an inner and outer polymer layer;
at least a portion of the tubular body including a tubular body; and
at least a portion of the tubular body being reinforced by two or more reinforcing members extending laterally between the inner and outer polymer layers,
wherein an outer surface of the two or more reinforcing members includes a plurality of cavities formed thereon via chemical treatment in an inorganic solvent bath, and
wherein an outer surface of the two or more reinforcing members includes an antibacterial surface formed thereon after the chemical treatment in an inorganic solvent bath via heat treatment.

2. The reinforcing tube of claim 1, wherein the inner and outer polymer layers are made of silicone.

3. The reinforcing tube of claim 1, wherein the two or more reinforcing members is a stainless steel wire.

4. The reinforcing tube of claim 1, wherein the shape of the two or more reinforcing members is cylindrical.

5. The reinforcing tube of claim 1, wherein portions of the tubular body have different flexibilities via the two or more reinforcing members.

6. The reinforcing tube of claim 3, wherein the ratio of inorganic solvent to water for the chemical treatment in the inorganic solvent bath forming the plurality of cavities on the outer surface of the two or more reinforcing members is in the range from 1.15:1 to 1.45:1.

7. The reinforcing tube of claim 3, wherein the temperature of the heat treatment for forming the antibacterial surface on the outer surface of the two or more reinforcing members is in the range from 470° C. to 760° C.

8. The reinforcing tube of claim 7, wherein the time period of the heat treatment for forming the antibacterial surface on the outer surface of the two or more reinforcing members is in the range 10 minutes to 60 minutes.

9. A method of making a tubular body for a reinforced tubing shaft, comprising the steps of:
Step (1110): providing two or more reinforcing members;
Step (1120): cleaning and rinsing the surfaces of the two or more reinforcing members;
Step (1130): immersing the two or more reinforcing members in an inorganic solvent bath for chemical treatment;
Step (1140): rinsing and drying the two or more reinforcing members;
Step (1150): heat treating the two or more reinforcing members;
Step (1210): providing a reinforced tubing mold and an extruder operatively associated therewith;
Step (1220): attaching the two or more reinforcing members to the reinforced tubing mold;
Step (1230): extruding a polymer material with a melting temperature into the reinforced tubing mold, wherein the polymer material surrounds the two or more reinforcing members forming a lumen and an inner and outer polymer layer;
Step (1240): heating the tubular body for bonding of the polymer material with the two or more reinforcing members;
Step (1250): cutting the tubular body for forming of the reinforced tubing; and
Step (1260): removing the reinforced tubing after cooling,
wherein the shaft has a proximal end and distal end, and the shaft, being flexible, extends between the proximal and distal ends and defines a lumen extending from a proximal port to a distal port and having the inner and outer polymer layer,
wherein at least a portion of the tubular body includes the tubular body,
wherein at least a portion of the tubular body is reinforced by the two or more reinforcing members extending laterally between the inner and outer polymer layers,
wherein an outer surface of the two or more reinforcing members includes a plurality of cavities formed thereon via Step (1130), and
wherein an outer surface of the two or more reinforcing members includes an antibacterial surface formed thereon after Step (1130) via Step (1150).

10. The method of making the tubular body of claim 9, wherein the inner and outer polymer layers are made of silicone.

11. The method of making the tubular body of claim 9, wherein the two or more reinforcing members is a stainless steel wire.

12. The method of making the tubular body of claim 9, wherein the shape of the two or more reinforcing members is cylindrical.

13. The method of making the tubular body of claim 9, wherein portions of the tubular body have different flexibilities via the two or more reinforcing members.

14. The method of making the tubular body of claim 11, wherein the ratio of inorganic solvent to water for the chemical treatment in the inorganic solvent bath forming the plurality of cavities on the outer surface of the two or more reinforcing members is in the range from 1.15:1 to 1.45:1.

15. The method of making the tubular body of claim 11, wherein the temperature of the heat treatment for forming the antibacterial surface on the outer surface of the two or more reinforcing members is in the range 470° C. to 760° C.

16. The method of making the tubular body of claim 11, wherein the time period of the heat treatment for forming the antibacterial surface on the outer surface of the two or more reinforcing members is in the range from 10 minutes to 60 minutes.
